(19) United States
(12) Patent Application Publication
(10) Pub. No.: US 2016/0020033 A1
(43) Pub. Date: Jan. 21, 2016

(54) COMPOSITE ELECTRONIC COMPONENT AND BOARD HAVING THE SAME

(71) Applicant: SAMSUNG ELECTRO-MECHANICS CO., LTD., Suwon-Si (KR)

(72) Inventors: Hong Kyu SHIN, Suwon-Si (KR); Hyun Sub OH, Suwon-Si (KR); Jae Hyuk CHOI, Suwon-Si (KR)

(21) Appl. No.: 14/637,093

(22) Filed: Mar. 3, 2015

(30) Foreign Application Priority Data
Jul. 18, 2014 (KR) 10-2014-0091217
Nov. 7, 2014 (KR) 10-2014-0154285

(51) Int. Cl. H01G 4/38; H01G 4/12; H01G 2/06; H01G 4/248; H01G 4/012; H01G 4/30; H01G 9/052

(52) U.S. Cl. CPC H01G 4/38; H01G 4/30; H01G 4/12; H01G 9/052; H01G 4/248; H01G 4/012; H01G 2/065

(57) ABSTRACT

A composite electronic component including a plurality of passive elements and a board having the same may includes: a tantalum capacitor including a body part containing a material formed of sintered tantalum powder and a tantalum wire disposed on one surface of the body part, a plurality of multilayer ceramic capacitors (MLCC) disposed upwardly of the tantalum capacitor and including a ceramic body in which a plurality of dielectric layers and internal electrodes are alternatingly disposed, and a molding part enclosing the tantalum capacitor and the plurality of multilayer ceramic capacitors.

### CROSS-REFERENCE TO RELATED APPLICATIONS

This application claims the priorities and benefits of Korean Patent Application Nos. 10-2014-0091217 filed on Jul. 18, 2014 and 10-2014-0154285 filed on Nov. 7, 2014, with the Korean Intellectual Property Office, the disclosures of which are incorporated herein by reference.

### BACKGROUND

The present inventive concept relates to a composite electronic component including a plurality of passive elements and a board having the same.

A multilayer ceramic capacitor (MLCC), a multilayer chip electronic component, is a chip-type condenser mounted on the printed circuit boards (PCBs) of various types of electronic products, such as image display devices including liquid crystal displays (LCDs), plasma display panels (PDPs), and the like, as well as, computers, smartphones, mobile phones, and the like, serving to charge electricity therein as well as to discharge electricity therefrom.

Such multilayer ceramic capacitors may be used as components in various types of electronic devices, due to advantages thereof such as a relatively small size, high capacitance, and ease in the mounting thereof. Multilayer ceramic capacitors may have a structure in which a plurality of dielectric layers are stacked in an alternating manner with internal electrodes having different polarities interposed therebetween.

Since the dielectric layer has piezoelectric and electrostrictive characteristics, a piezoelectric phenomenon may occur between the internal electrodes when a direct current (DC) or alternating current (AC) voltage is applied to a multilayer ceramic capacitor, such that vibrations may be generated.

These vibrations may be transferred to a PCB on which the multilayer ceramic capacitor is mounted through solders of the multilayer ceramic capacitor, such that the entire PCB may become a sound radiating surface generating vibrational sound, commonly known as noise.

The vibrational sound may correspond to noise within an audio frequency range of 20 to 20000 hertz (Hz), sound which may cause discomfort to listeners thereof. Vibrational sound causing listener discomfort, as described above may be termed acoustic noise.

Research into a product having a form in which an area of a lower cover layer of the multilayer ceramic capacitor is increased in order to decrease acoustic noise has been conducted.

However, research into a product having an improved acoustic noise reduction effect is further required.

### RELATED ART DOCUMENT

Japanese Patent Laid-Open Publication No. 1997-326334

### SUMMARY

An exemplary embodiment in the present disclosure may provide a composite electronic component having an excellent acoustic noise reduction effect.

An exemplary embodiment in the present disclosure may also provide a composite electronic component having relatively low equivalent series resistance (ESR)/equivalent series inductance (ESL), improved DC-bias characteristics, and a relatively reduced chip thickness.

According to An exemplary embodiment in the present disclosure, a composite electronic component may include: a tantalum capacitor including a body part containing a material formed of sintered tantalum powder and a tantalum wire disposed on one surface of the body part, a plurality of multilayer ceramic capacitors disposed upwardly of the tantalum capacitor and including a ceramic body in which a plurality of dielectric layers and internal electrodes are alternatingly disposed, and a molding part enclosing the tantalum capacitor and the plurality of multilayer ceramic capacitors.

According to another aspect of the present inventive concept, a board having a composite electronic component may include: a printed circuit board (PCB) on which electrode pads are disposed; and the composite electronic component mounted on the PCB, wherein the composite electronic component includes a tantalum capacitor including a body part containing a material formed of sintered tantalum powder and a tantalum wire disposed on one surface of the body part, a plurality of multilayer ceramic capacitors disposed upwardly of the tantalum capacitor and including a ceramic body in which a plurality of dielectric layers and internal electrodes are alternatingly disposed, and a molding part enclosing the tantalum capacitor and the plurality of multilayer ceramic capacitors.

### BRIEF DESCRIPTION OF DRAWINGS

The above and other aspects, features and other advantages of the present inventive concept will be more clearly understood from the following detailed description taken in conjunction with the accompanying drawings, in which:

FIG. 1 is a projected perspective view of electrodes and a molding part of a composite electronic component according to an exemplary embodiment of the present inventive concept;

FIG. 2 is a plan view of FIG. 1;

FIG. 3 is a bottom view of FIG. 1;

FIG. 4 is a cross-sectional view taken along line A-A′ of FIG. 1;

FIG. 5 is a cross-sectional view taken along line B-B′ of FIG. 1;

FIG. 6 is a projected perspective view of electrodes and a molding part of a composite electronic component according to another exemplary embodiment of the present inventive concept;

FIG. 7 is a plan view of FIG. 6;

FIG. 8 is a bottom view of FIG. 6;

FIGS. 9A and 9B are graphs illustrating equivalent series resistances (ESR) versus a frequency of a composite electronic component according to Inventive Example and Comparative Example, and impedance versus a frequency of a composite electronic component according to Inventive Example and Comparative Example, respectively;

FIG. 10 is a graph illustrating an output voltage versus time according to Inventive Example and Comparative Example;

FIG. 11 is a graph illustrating a voltage ripple (ΔV) versus ESR based on a volume ratio between a multilayer ceramic capacitor and a tantalum capacitor in a composite electronic component according to an exemplary embodiment of the present inventive concept; and

FIG. 12 is a perspective view illustrating a form in which the composite electronic component of FIG. 1 is mounted on a printed circuit board (PCB).

### DETAILED DESCRIPTION

Exemplary embodiments of the present inventive concept will now be described in detail with reference to the accompanying drawings.

The inventive concept may, however, be exemplified in many different forms and should not be construed as being limited to the specific embodiments set forth herein. Rather, these embodiments are provided so that this disclosure will be thorough and complete, and will fully convey the scope of the inventive concept to those skilled in the art.

In the drawings, the shapes and dimensions of elements may be exaggerated for clarity, and the same reference numerals will be used throughout to designate the same or like elements.

Directions of a hexahedron will be defined in order to clearly describe exemplary embodiments of the present inventive concept. L, W and T shown in the accompanying drawings refer to a length direction, a width direction, and a thickness direction, respectively.

Composite Electronic Component

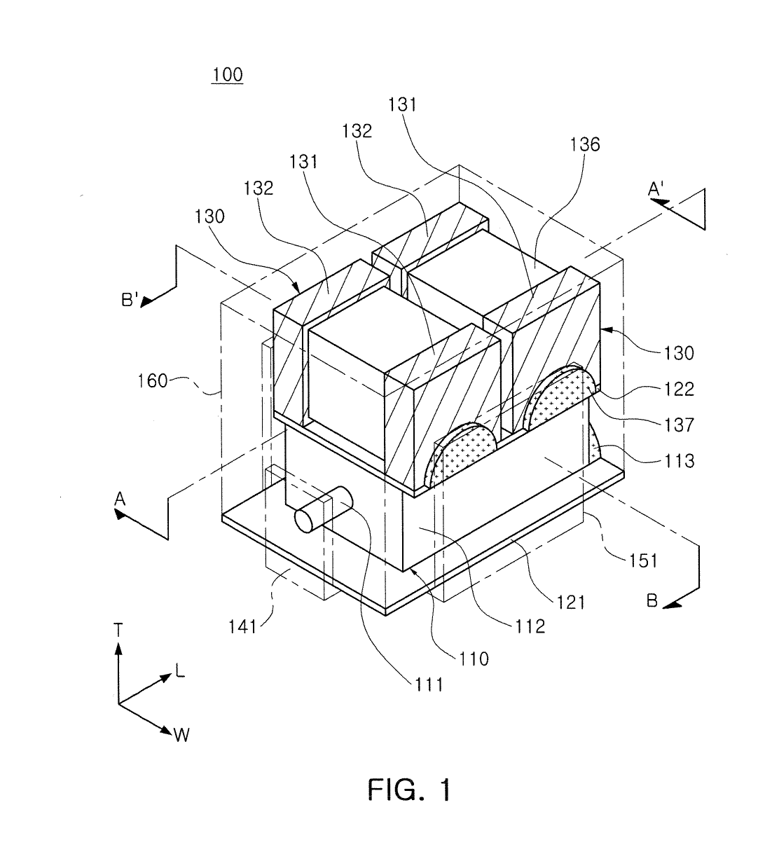

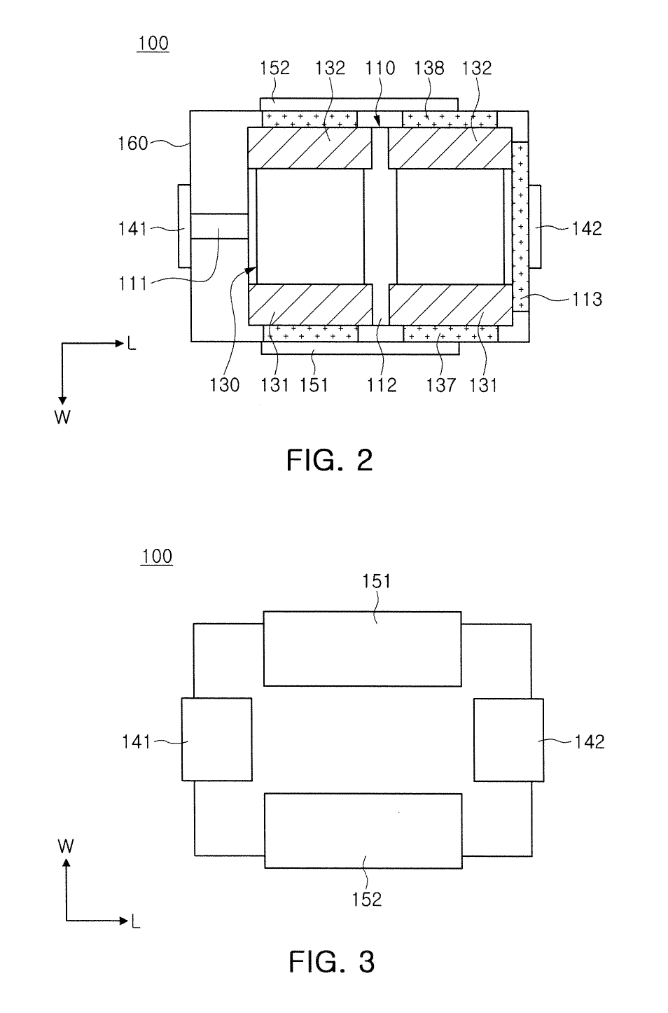

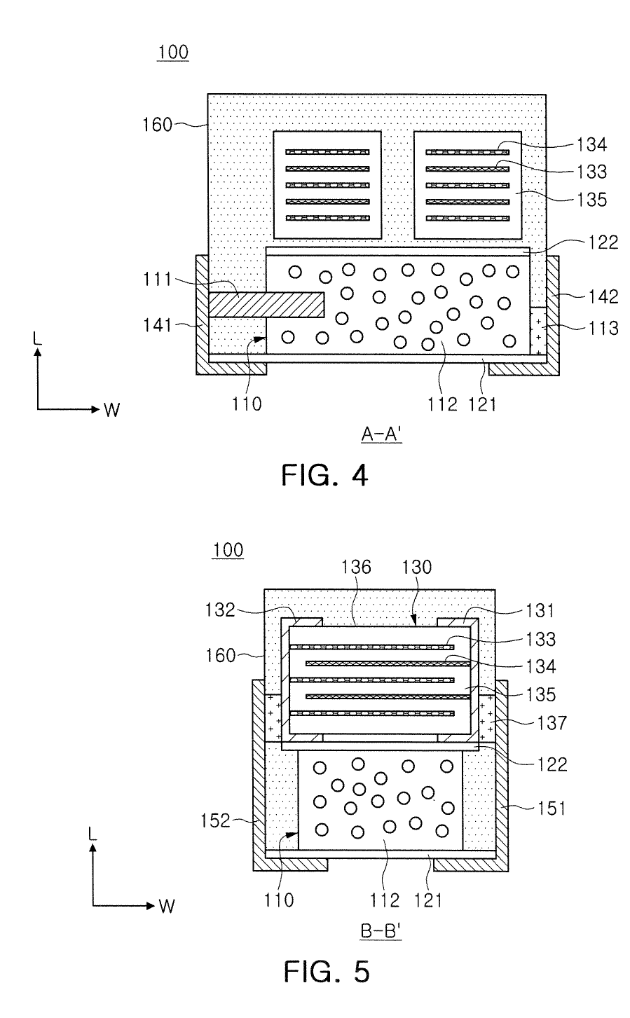

FIG. 1 is a projected perspective view of electrodes and a molding part 160 of a composite electronic component 100 according to an exemplary embodiment of the present inventive concept; FIG. 2 is a plan view of FIG. 1; FIG. 3 is a bottom view of FIG. 1; FIG. 4 is a cross-sectional view taken along line A-A′ of FIG. 1; and FIG. 5 is a cross-sectional view taken along line B-B′ of FIG. 1.

Referring to FIGS. 1 through 3, the composite electronic component 100 according to the exemplary embodiment of the present inventive concept may include a tantalum capacitor 110 including a body part 112 containing a material formed of sintered tantalum powder and a tantalum wire 111 disposed on one surface of the body part 112, a plurality of multilayer ceramic capacitors (MLCC) 130 disposed upwardly of the tantalum capacitor 110 and including a ceramic body 136 in which a plurality of dielectric layers 135 and internal electrodes 133 and 134 are alternatingly disposed, and a molding part 160 enclosing the tantalum capacitor 110 and the plurality of multilayer ceramic capacitors 130.

In addition, when among the internal electrodes, internal electrodes exposed to one surface of the ceramic body 136 are defined as first internal electrodes 133 and internal electrodes exposed to a surface opposing one surface of the ceramic body 136 are defined as second internal electrodes 134, each of the plurality of multilayer ceramic capacitors 130 may further include a first external electrode 131 connected to the first internal electrodes 133 and a second external electrode 132 connected to the second internal electrodes 134.

The molding part 160 may be formed to enclose the multilayer ceramic capacitors and the tantalum capacitor. The molding part 160 may serve to protect the multilayer ceramic capacitors and the tantalum capacitor from external environments, and may be mainly formed of an epoxy mold compound (EMC) based on epoxy or silica, or the like. However, the type of material forming the molding part 160 is not limited thereto.

The composite electronic component 100 according to the exemplary embodiment of the present inventive concept may be provided as a single component in which the multilayer ceramic capacitors and the tantalum capacitor are coupled to each other, due to the molding part 160.

The multilayer ceramic capacitor is not particularly limited, and various types of multilayer ceramic capacitor may be used.

For example, the multilayer ceramic capacitor may include the ceramic body 136 in which the plurality of dielectric layers 135 and the internal electrodes 133 and 134 disposed with each of the dielectric layers 135 interposed therebetween are stacked and the external electrodes 131 and 132 formed on outer surfaces of the ceramic body 136 to be connected to the internal electrodes 133 and 134, respectively. The internal electrodes may be classified into the first and second internal electrodes 133 and 134, wherein the first and second internal electrodes 133 and 134 may be alternatingly disposed on the dielectric layers 135 with each of the dielectric layers 135 interposed therebetween. The first internal electrode 133 may be exposed to one side surface of the ceramic body 136 and the second internal electrode 134 may be exposed to a surface of the ceramic body 136 opposing one side surface of the ceramic body 136.

The ceramic body 136 may be formed by stacking the plurality of dielectric layers 135 and the internal electrodes and then sintering the stacked dielectric layers 135 and internal electrodes.

Further, the dielectric layer 135 may contain ceramic powder having a high-k, for example, barium titanate (BaTiO₃) based powder or strontium titanate (SrTiO₃) based powder. However, the type of material contained in the dielectric layer is not limited thereto.

The first and second internal electrodes 133 and 134 may be formed using a conductive paste formed of at least one of, for example, a noble metal material such as palladium (Pd), a palladium-silver (Pd—Ag) alloy, or the like, nickel (Ni), and copper (Cu), but the material forming the first and second internal electrodes is not particularly limited thereto.

The external electrodes may be disposed on the outer surfaces of the ceramic body 136, respectively, to thereby be electrically connected to the internal electrodes. The external electrodes may include the first and second external electrodes 131 and 132. The first external electrode 131 may be electrically connected to the first internal electrodes 133, and the second external electrode 132 may be electrically connected to the second internal electrodes 134.

According to the exemplary embodiment of the present inventive concept, a nickel/tin (Ni/Sn) plating layer may not be disposed on the first and second external electrodes 131 and 132 unlike in a case of a general multilayer ceramic capacitor. Since the composite electronic component 100 according to the exemplary embodiment of the present inventive concept includes the molding part 160 enclosing the multilayer ceramic capacitors 130 and the tantalum capacitor 110 as will be described hereinbelow, the plating layers do not need to be formed on the first and second external electrodes 131 and 132 of the multilayer ceramic capacitors 130.

Therefore, an issue of reliability being decreased due to permeation of a plating solution into the ceramic body 136 of the multilayer ceramic capacitor may be prevented.

The tantalum capacitor may include the body part 112 and the tantalum wire 111, and the tantalum wire 111 may be embedded in the body part 112 so that a portion of the tantalum wire 111 in the length direction of the body part 112 is exposed to one surface of the body part 112.

Although not limited thereto, the body part 112 of the tantalum capacitor 110 may include a positive electrode body, a dielectric layer, a solid electrolyte layer, a carbon layer, and a negative electrode layer.

The positive electrode body may be formed of a porous material of sintered tantalum powder.

The dielectric layer the body part 112 may be formed on a surface of the positive electrode body. The dielectric layer of the body part 112 may be formed by oxidizing the surface of the positive electrode body. For example, the dielectric layer of the body part 112 may be formed of a dielectric material containing tantalum oxide (Ta₂O₅), which is an oxide of tantalum forming the positive electrode body, and may be formed on the surface of the positive electrode body at a predetermined thickness.

The solid electrolyte layer may be formed on a surface of the dielectric layer of the body part 112. The solid electrolyte layer may contain at least one of a conductive polymer or manganese dioxide (MnO₂). In a case in which the solid electrolyte layer is formed of a conductive polymer, the solid electrolyte layer may be formed on the dielectric layer of the body part 112 using a chemical polymerization process or an electrolytic polymerization process. The conductive polymer raw material is not particularly limited as long as it has conductivity. For example, the conductive polymer raw material may contain polypyrrole, polythiophene, polyaniline, or the like.

In a case in which the solid electrolyte layer is formed of MnO₂, a conductive MnO₂ may be formed on the surface of the dielectric layer of the body part 112 by immersing the positive electrode body having the dielectric layer formed on the surface of the positive electrode body in a manganese aqueous solution such as a manganese nitrate solution and pyrolyzing the manganese aqueous solution.

The carbon layer containing carbon may be disposed on the solid electrolyte layer.

The carbon layer may be formed of carbon pastes. That is, the carbon layer may be formed by applying carbon pastes dispersed in water or an organic solvent onto the solid electrolyte layer in a state in which conductive carbon raw material powder such as natural graphite, carbon black, or the like, is mixed with a binder, a dispersant, or the like.

The negative electrode layer containing a conductive metal may be disposed on the carbon layer in order to improve electric connectivity with a negative electrode terminal 142, wherein the conductive metal contained in the negative electrode layer may be Ag.

The tantalum capacitor 110 is not particularly limited, but for example, a tantalum capacitor 110 having a structure in which an internal lead frame is absent may be used.

According to the exemplary embodiment of the present inventive concept, the composite electronic component 100 may further include a positive electrode terminal 141 connected to the tantalum wire 111 of the tantalum capacitor 110 and disposed outwardly of the molding part 160, the negative electrode terminal 142 connected to the body part 112 and disposed outwardly of the molding part 160, a first external terminal 151 connected to the first external electrodes 131 of the multilayer ceramic capacitor 130 and disposed outwardly of the molding part 160, and a second external terminal 152 connected to the second external electrodes 132 and disposed outwardly of the molding part 160.

The negative electrode terminal 142 may be connected directly to the body part 112, but may also be connected to the body part 112 through a connection conductor part 113. In addition, the first external electrodes 131 may be connected directly to the first external terminal 151 and the second external electrodes 132 may be connected directly to the second external terminal 152, but the first external electrodes 131 may be connected directly to the first external terminal 151 through separate connection conductor parts 137 and the second external electrodes 132 may be connected directly to the second external terminal 152through separate connection conductor parts 138.

Shapes of the connection conductor parts 113, 137, and 138 are not particularly limited as long as they may electrically connect the positive and negative electrode terminals 141 and 142, and the first and second external terminals 151 and 152 provided outwardly of the molding part 160 to the tantalum capacitor 110 and the multilayer ceramic capacitors 130 provided inwardly of the molding part 160, respectively.

The connection conductor parts 113, 137, and 138 may be conductive resin parts formed by curing conductive resin pastes. The conductive resin part may contain conductive particles and a base resin. The conductive particles may be Ag particles but are not limited thereto, and the base resin maybe a thermosetting resin, for example, an epoxy resin. In addition, the conductive resin part may contain Cu as a conductive metal, but is not necessarily limited thereto.

The positive electrode terminal 141, the negative electrode terminal 142, and the first and second external terminals 151 and 152 may be connected to an external power source to serve to send a current to the tantalum wire 111, the body part 112, and the first and second external electrodes 131 and 132. That is, the positive electrode terminal 141, the negative electrode terminal 142, and the first and second external terminals 151 and 152 maybe exposed outwardly of the molding part 160 to thereby be used as connection terminals for an electric connection to another electronic product.

The positive electrode terminal 141, the negative electrode terminal 142, and the first and second external terminals 151 and 152 may be formed by processes of dry-depositing, for example, sputtering, and plating at least one of chromium (Cr), titanium (Ti), Cu, Ni, Pd, and gold (Au), forming and etching a metal layer of at least one of Cr, Ti, Cu, Ni, Pd, and Au, but the process of forming the positive negative electrode terminals 141 and 142 and the first and second external terminals 151 and 152 is not limited thereto.

The tantalum wire 111 may contain a tantalum ingredient, may be inserted into the body part 112 of the tantalum capacitor 110, and may be connected to the external power source through the positive electrode terminal 141 to form a positive electrode.

According to the exemplary embodiment of the present inventive concept, as illustrated in FIGS. 1 and 2, the tantalum wire 111 may be disposed as if the tantalum wire 111 is led out from one surface of the body part 112 of the tantalum capacitor 110. In addition, the tantalum wire 111 may not be led out from a central portion of the body part 112 but may be disposed to be biased, that is, offset, towards one side of the body part 112. The tantalum wire 111 may be disposed to be offset towards one side of the body part 112, such that it may be relatively easy to secure a space of the composite electronic component 100 in which the multilayer ceramic capacitors 130 are mounted upwardly of the tantalum capacitor 110 and it may be relatively easy to dispose the positive electrode and the negative electrode.

Since the plurality of multilayer ceramic capacitors 130 are disposed upwardly of the body part 112 of the tantalum capacitor 110, in order to insulate the plurality of multilayer ceramic capacitors 130 and the body part 112 of the tantalum capacitor 110 from each other, the plurality of multilayer ceramic capacitors 130 and the body part 112 of the tantalum capacitor 110 may be disposed to be spaced apart from each other by a predetermined distance or more. Although the case in which the plurality of multilayer ceramic capacitors 130 and the body part 112 of the tantalum capacitor 110 are insulated from each other by disposing an insulation sheet 122 therebetween is illustrated in the exemplary embodiment of FIGS. 1 through 5, the present inventive concept is not limited thereto. The insulation sheet 122 is not particularly limited as long as it has insulation properties, and the insulation sheet 122 may be manufactured using an insulation material such as a ceramic based material, or the like.

The plurality of multilayer ceramic capacitors 130 may be disposed so that the first external electrodes 131 thereof come in contact with each other and the second external electrodes 132 thereof come in contact with each other. Further, in order to improve mounting stability of the multilayer ceramic capacitors 130, the multilayer ceramic capacitors 130 may be disposed to be spaced apart from each other.

Referring to FIGS. 1 through 5, the first external electrodes 131 of each of the plurality of multilayer ceramic capacitors 130 may be connected to each other by a common first external terminal 151, and the second external electrodes 132 of each of the plurality of multilayer ceramic capacitors 130 may be connected to each other by a common second external terminal 152. Here, by adding a separate electrode that is not illustrated in FIGS. 1 through 5, the positive electrode terminal 141, the negative electrode terminal 142, and the first and the second external terminals 151 and 152 may be disposed so that the positive electrode terminal 141 and the first external terminal 151 are connected to each other and the negative electrode terminal 142 and the second external terminal 152 are connected to each other.

In order to facilitate a connection between the positive electrode terminal 141 and the first external terminal 151 and a connection between the negative electrode terminal 142 and the second external terminal 152, the positive electrode terminal 141, the negative electrode terminal 142, and the first and the second external terminals 151 and 152 may be disposed so that the positive electrode terminal 141 and the negative electrode terminal 142 are disposed on both side surfaces of the composite electronic component 100 in the length direction of the composite electronic component 100, respectively, to be extended onto a lower surface of the composite electronic component 100 and the first and second external terminals 151 and 152 are disposed on both side surfaces of the composite electronic component 100 in the width direction of the composite electronic component 100, respectively, to be extended onto the lower surface of the composite electronic component 100.

In order to prevent an electrical short-circuit of the body part 112 of the tantalum capacitor 110 with the first external terminal 151 and the positive electrode terminal 141, an insulation sheet 121 may be disposed on a lower surface of the body part 112.

In the case in which the first external electrodes 131 are connected by the common first external terminal and the second external electrodes 132 are connected by the common second external terminal, the plurality of multilayer ceramic capacitors 130 may be connected in parallel with each other. In addition, when the first external terminal 151 and the positive electrode terminal 141 are connected to each other and the second external terminal 152 and the negative electrode terminal 142 are connected to each other, the multilayer ceramic capacitors 130 and the tantalum capacitor 110 maybe connected in parallel with each other.

According to the exemplary embodiment of the present inventive concept, in order to secure the space in the composite electronic component 100 in which the multilayer ceramic capacitors are disposed upwardly of the body part 112, the tantalum capacitor 110 may be connected to the external power source by the positive electrode terminal 141 and the negative electrode terminal 142 and may not include a separate lead frame.

Since a general tantalum capacitor is connected to the external power source by a lead frame, an area of the tantalum capacitor occupied by the lead frame therein may be relatively great, whereby a limitation is imposed on increasing capacitance of the tantalum capacitor. According to the exemplary embodiment of the present inventive concept, relatively high capacitance may be provided and the composite electronic component 100 in which the plurality of multilayer ceramic capacitors 130 are coupled to the tantalum capacitor 110 may be relatively readily provided by using the tantalum capacitor that does not include such a lead frame.

In general, in the tantalum capacitor, relatively high capacitance is provided, DC-bias characteristics are excellent, and at the time of mounting of the tantalum capacitor on a board, acoustic noise is not generated. On the other hand, equivalent series resistance (ESR) is relatively high.

In general, in the multilayer ceramic capacitor, ESR and ESL are relatively low, but DC-bias characteristics are not as satisfactory as compared to those of the tantalum capacitor, and providing relatively high capacitance is difficult. In addition, a chip thickness of the multilayer ceramic capacitor is relatively great, and at the time of mounting of the multilayer ceramic capacitor on the board, acoustic noise is generated.

According to the exemplary embodiment of the present inventive concept, in the composite electronic component 100 including a composite body in which the multilayer ceramic capacitors 130 and the tantalum capacitor 110 are coupled to each other, since the multilayer ceramic capacitors 130 are disposed upwardly of the tantalum capacitor 110, the multilayer ceramic capacitor 130 may not be mounted on a circuit board while in direct contact with the circuit board. Therefore, a relatively excellent acoustic noise reduction effect may be achieved in the composite electronic component 100.

In addition, according to the exemplary embodiment of the present inventive concept, since the multilayer ceramic capacitor 130 and the tantalum capacitor 110 are connected to each other by the connection conductor parts 113, 137, and 138, the positive and negative electrode terminals 141 and 142, and the first and second external terminals 151 and 152, there is no need for a separate lead frame, relatively high capacitance may be provided, relatively low ESR/ESL may be provided, DC-bias characteristics may be improved, and a chip thickness may be decreased.

Since the composite electronic component 100 according to the exemplary embodiment of the present inventive concept includes the composite body in which the multilayer ceramic capacitors and the tantalum capacitor are coupled to each other, relatively high ESR, a disadvantage of the tantalum capacitor, may be decreased.

In addition, deterioration of DC-bias characteristics, a disadvantage of the multilayer ceramic capacitor, may be prevented, and a relatively reduced chip thickness may be achieved. In addition, according to the exemplary embodiment of the present inventive concept, the multilayer ceramic capacitors 130 that generate acoustic noise at the time of being mounted on the board and the tantalum capacitor 110 that does not generate acoustic noise at the time of being mounted on the board may be coupled to each other at a predetermined volume ratio, such that the acoustic noise reduction effect may be excellent.

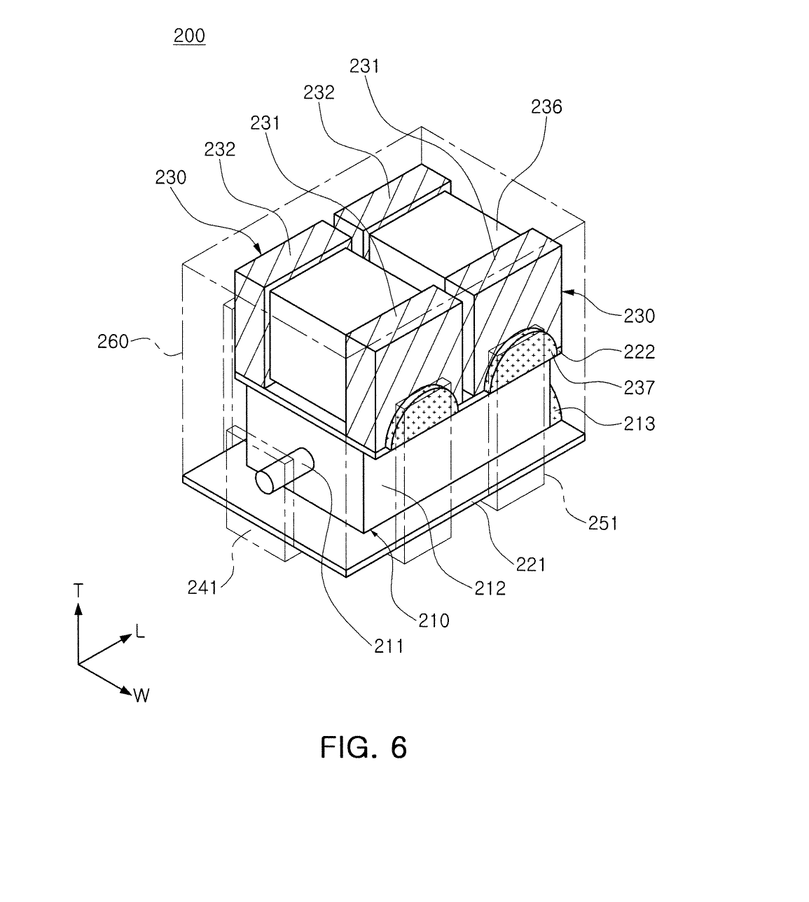

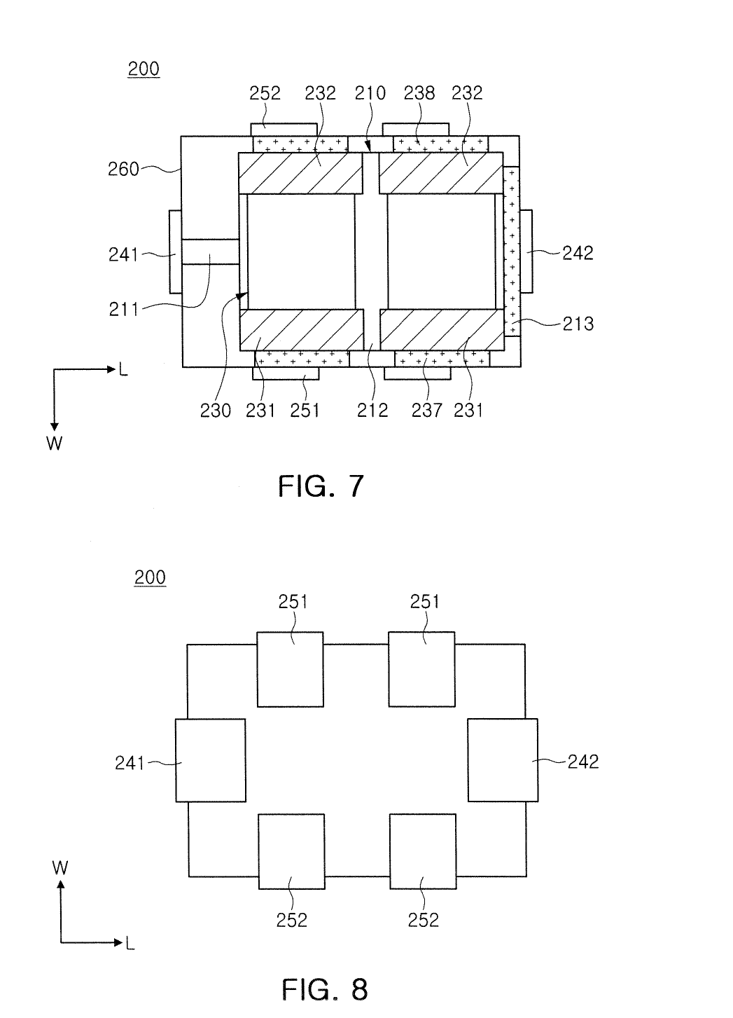

Referring to FIGS. 6 through 8, in a composite electronic component 200 according to another exemplary embodiment of the present inventive concept, first external electrodes 231 of a plurality of multilayer ceramic capacitors 230 may be connected to a plurality of first external terminals 251 disposed to be spaced apart from each other, respectively, and second external electrodes 232 of the plurality of multilayer ceramic capacitors 230 may be connected to a plurality of second external terminals 252 disposed to be spaced apart from each other, respectively. In this case, the plurality of multilayer ceramic capacitors 230 may be disposed to be spaced apart from each other so that the first and second external electrodes 231 and 232 thereof do not come in contact with each other.

Referring to FIGS. 6 through 8, a positive electrode terminal 241 and a negative electrode terminal 242 may be disposed on both side surfaces of the composite electronic component 200 in the length direction of the composite electronic component 200, and the plurality of first external terminals 251 connected to the first external electrodes 231 of the plurality of multilayer ceramic capacitors 230, respectively, may be disposed on one side surface of the composite electronic component 200 in the width direction of the composite electronic component 200. Further, the plurality of second external terminals 252 connected to the second external electrodes 232 of the plurality of multilayer ceramic capacitors 230, respectively, may be disposed on the other side surface of the composite electronic component 200 in the width direction of the composite electronic component 200.

In order to facilitate a connection between the composite electronic component 200 and an external power source, the positive electrode terminal 241, the negative electrode terminal 242, and the first and second external terminals 251 and 252 may be extended onto a lower surface of the composite electronic component 200. In this case, referring to FIG. 8, the composite electronic component 200 according to the other exemplary embodiment of the present inventive concept may include a total of 6 terminals.

Since a case in which the composite electronic component 200 includes two multilayer ceramic capacitors 230 is illustrated in FIGS. 6 through 8, the composite electronic component 200 may include a total of 6 terminals, and in a case in which the composite electronic component 200 includes three multilayer ceramic capacitors 230, the composite electronic component 200 may include a total of 8 terminals.

Each of the terminals may be variously connected based on a disposition of electrode pads of a board on which the composite electronic component 200 is to be mounted, such that the tantalum capacitor 210 and the plurality of multilayer ceramic capacitors 230 may also be variously connected, but the present inventive concept is not limited thereto.

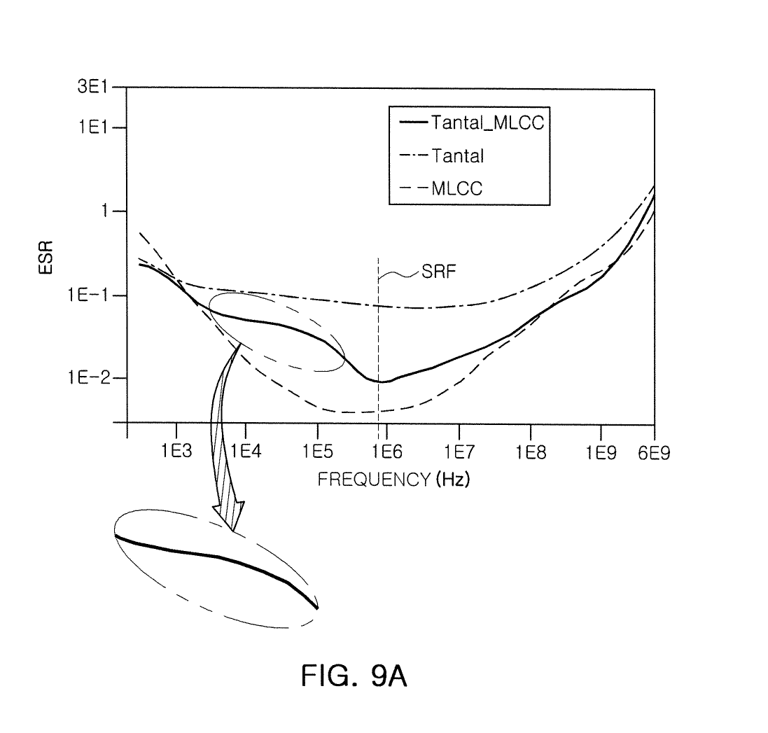

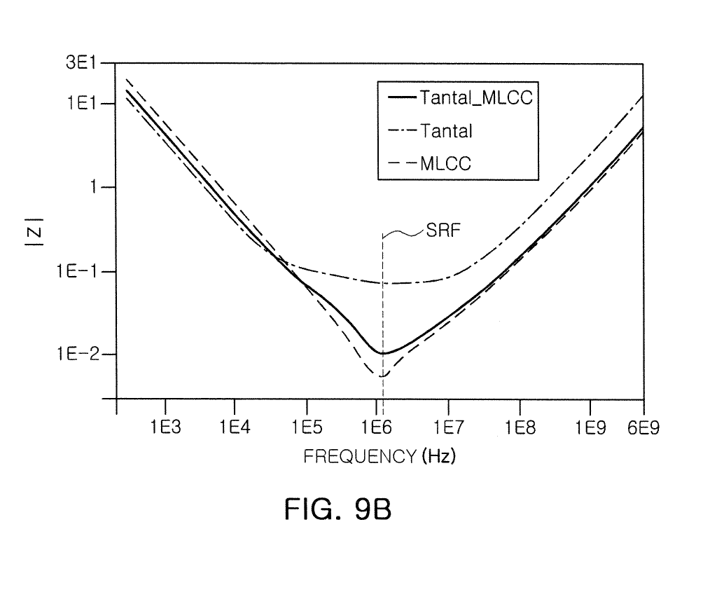

FIGS. 9A and 9B are graphs illustrating ESR versus a frequency of the composite electronic component 100 according to Inventive Example and Comparative Example, and impedance versus a frequency of the composite electronic component 100 according to Inventive Example and Comparative Example, respectively.

Referring to FIGS. 9A and 9B, in the case of the composite electronic component 100 according to the exemplary embodiment of the present inventive concept, inflection points of ESR and impedance may be generated in at least one region of frequency bands prior to and subsequent to a self resonant frequency (SRF) in the graphs illustrating ESR and impedance versus the frequency of the input signal.

That is, according to Inventive Example, in the graph illustrating impedance versus the frequency, impedance of the tantalum capacitor 110 may appear in a relatively low frequency band, and impedance of the multilayer ceramic capacitor 130 may appear in a relatively high frequency band.

Therefore, in the graphs illustrating ESR versus the frequency of the input signal and impedance versus the frequency of the input signal, respectively, the inflection points of the ESR and impedance may be generated in at least one of the frequency bands prior to and subsequent to the SRF.

The inflection points of the ESR and impedance may be generated in at least one of the frequency bands prior to and subsequent to the SRF.

Since the inflection points of the ESR and impedance are generated in at least one of the frequency bands prior to and subsequent to the SRF, in the composite electronic component 100 according to the exemplary embodiment of the present inventive concept, relatively low ESR may be provided.

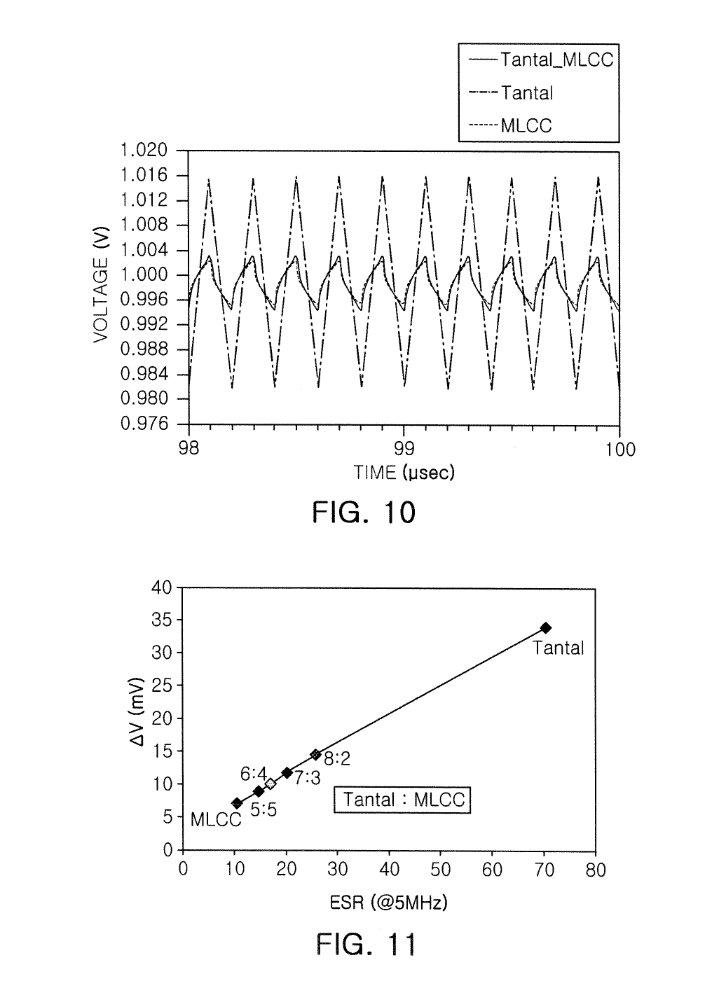

FIG. 10 is a graph illustrating an output voltage versus time, according to Inventive Example and Comparative Example.

Referring to FIG. 10, it may be appreciated that, a voltage ripple of Inventive Example is significantly decreased as compared to that of Comparative Example in which only the tantalum capacitor is used, and is substantially similar to that of Comparative Example in which only the multilayer ceramic capacitor is used.

That is, it may be appreciated that in the case of Comparative Example in which only the tantalum capacitor is used, a voltage ripple is 34 millivolts (mV), while in the case of Inventive Example, a voltage ripple is decreased to 9 mV, which is similar to a voltage ripple (7 mV) of Comparative Example in which only the multilayer ceramic capacitor is used.

FIG. 11 is a graph illustrating a voltage ripple (ΔV) versus ESR based on a volume ratio between the multilayer ceramic capacitor 130 and the tantalum capacitor 110 in the composite electronic component 100 according to the exemplary embodiment of the present inventive concept.

Referring to FIG. 11, it may be appreciated that in the exemplary embodiment of the present inventive concept, in a case in which a volume ratio between the tantalum capacitor 110 and the multilayer ceramic capacitor 130 coupled to each other is 5:5 to 7:3, an electronic component having relatively low ESR, a relatively low voltage ripple (ΔV) value, and relatively high capacitance may be provided.

Board Having Composite Electronic Component

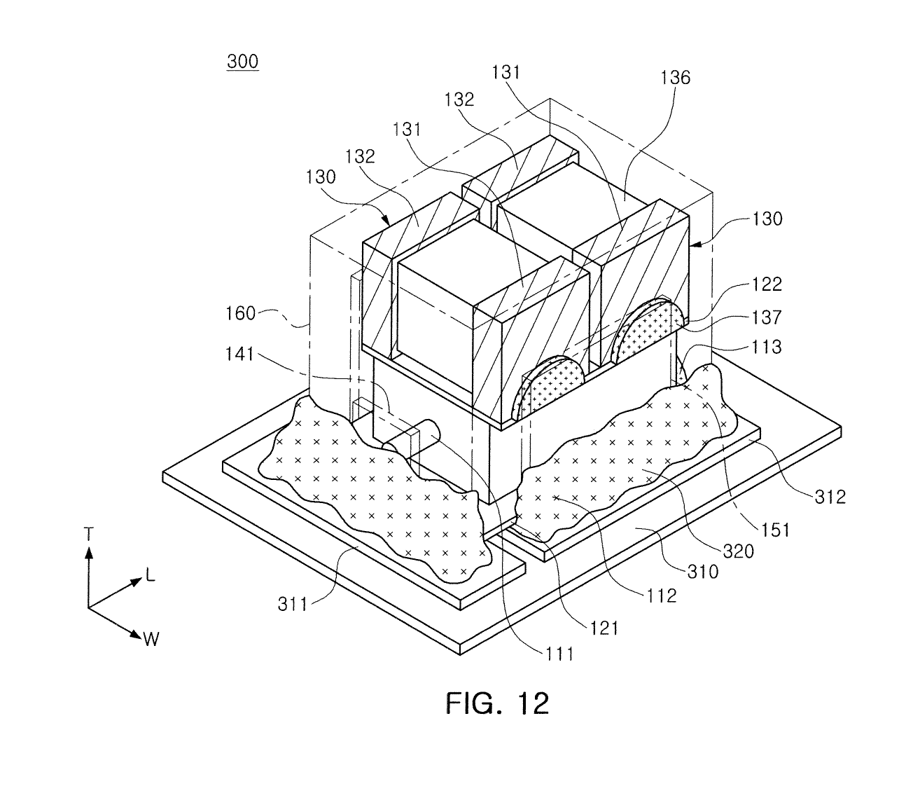

FIG. 12 is a perspective view illustrating a form in which the composite electronic component 100 of FIG. 1 is mounted on a PCB 310.

Referring to FIG. 12, a board 300 having a composite electronic component according to another exemplary embodiment of the present inventive concept may include the PCB 310 on which electrode pads 311 and 312 are disposed, and the composite electronic component 100 mounted on the PCB 310. The composite electronic component 100 may include the tantalum capacitor 110 including the body part 112 containing the material formed of sintered tantalum powder and the tantalum wire 111 disposed on one surface of the body part 112, the plurality of multilayer ceramic capacitors 130 disposed upwardly of the tantalum capacitor 110 and including the ceramic body 136 in which the plurality of dielectric layers 135 and internal electrodes 133 and 134 are alternatingly disposed, and the molding part 160 enclosing the tantalum capacitor 110 and the plurality of multilayer ceramic capacitors 130.

The composite electronic composite illustrated in FIG. 12 is the composite electronic component 100 illustrated in FIGS. 1 through 5. Among the electrode pads disposed on the board having the composite electronic component 100, an electrode pad connected to the positive electrode terminal 141 and the first external terminal 151 of the composite electronic component 100 may be defined as a first electrode pad 311, and an electrode pad connected to the negative electrode terminal 142 and the second external terminal 152 may be defined as a second electrode pad 312. The terminals of the composite electronic component 100 and the first and second electrode pads 311 and 312 may be coupled to each other by solders 320.

In the case in which the terminals of the composite electronic component 100 and the first and second electrode pads 311 and 312 are connected to each other as illustrated in FIG. 12, the plurality of multilayer ceramic capacitors 130 and the tantalum capacitor 110 may be connected in parallel with each other.

As set forth above, according to exemplary embodiments of the present inventive concept, the composite electronic component having an excellent acoustic noise reduction effect may be provided.

In addition, according to exemplary embodiments of the present inventive concept, the composite electronic component capable of providing relatively high capacitance, having relatively low ESR/ESL, improved DC-bias characteristics, and a relatively reduced chip thickness may be provided.

Further, according to exemplary embodiments of the present inventive concept, improved space efficiency may be provided in the composite electronic component.

While exemplary embodiments have been shown and described above, it will be apparent to those skilled in the art that modifications and variations could be made without departing from the scope of the invention as defined by the appended claims.

What is claimed is:

1. A composite electronic component comprising:
a tantalum capacitor including a body part containing a material formed of sintered tantalum powder and a tantalum wire disposed on one surface of the body part;
a plurality of multilayer ceramic capacitors (MLCC) disposed upwardly of the tantalum capacitor and including a ceramic body in which a plurality of dielectric layers and internal electrodes are alternatingly disposed; and
a molding part enclosing the tantalum capacitor and the plurality of multilayer ceramic capacitors.

2. The composite electronic component of claim 1, wherein when among the internal electrodes, internal electrodes exposed to one surface of the ceramic body are defined as first internal electrodes and internal electrodes exposed to a surface opposing one surface are defined as second internal electrodes, the plurality of multilayer ceramic capacitors further include a first external electrode connected to the first internal electrodes and a second external electrode connected to the second internal electrodes.

3. The composite electronic component of claim 2, further comprising:
a positive electrode terminal connected to the tantalum wire and disposed outwardly of the molding part;
a negative electrode terminal connected to the body part of the tantalum capacitor and disposed outwardly of the molding part;
a first external terminal connected to the first external electrode and disposed outwardly of the molding part; and
a second external terminal connected to the second external electrode and disposed outwardly of the molding part.

4. The composite electronic component of claim 3, wherein the first external electrodes of the plurality of multilayer ceramic capacitors are connected to each other by a common first external terminal, and the second external electrodes of the plurality of multilayer ceramic capacitors are connected to each other by a common second external terminal.

5. The composite electronic component of claim 3, wherein the first external electrodes of the plurality of multilayer ceramic capacitors are connected to a plurality of first external terminals disposed to be spaced apart from each other, respectively, and the second external electrodes of the plurality of multilayer ceramic capacitors are connected to a plurality of second external terminals disposed to be spaced apart from each other, respectively.

6. The composite electronic component of claim 3, wherein the positive electrode terminal and the negative electrode terminal are disposed on both side surfaces of the composite electronic component in a length direction of the composite electronic component, respectively, to be extended onto a lower surface of the composite electronic component, and the first and second external terminals are disposed on both side surfaces of the composite electronic component in a width direction of the composite electronic component, respectively, to be extended onto the lower surface of the composite electronic component.

7. The composite electronic component of claim 3, wherein the positive electrode terminal and the first external terminal are connected to each other, and the negative electrode terminal and the second external terminal are connected to each other.

8. The composite electronic component of claim 1, wherein in a graph illustrating equivalent series resistance (ESR) versus a frequency of an input signal, an inflection point of ESR is generated in at least one of frequency bands prior to and subsequent to a self resonance frequency (SRF).

9. The composite electronic component of claim 1, wherein a volume ratio between the tantalum capacitor and the multilayer ceramic capacitor coupled to each other is 5:5 to 7:3 (tantalum capacitor:multilayer ceramic capacitor).

10. A board having a composite electronic component, the board comprising:
a printed circuit board (PCB) on which electrode pads are disposed; and
a composite electronic component mounted on the PCB,
wherein the composite electronic component includes a tantalum capacitor including a body part containing a material formed of sintered tantalum powder and a tantalum wire disposed on one surface of the body part, a plurality of multilayer ceramic capacitors (MLCC) disposed upwardly of the tantalum capacitor and including a ceramic body in which a plurality of dielectric layers and internal electrodes are alternatingly disposed, and a molding part enclosing the tantalum capacitor and the plurality of multilayer ceramic capacitors.

11. The board of claim 10, wherein when among the internal electrodes, internal electrodes exposed to one surface of the ceramic body are defined as first internal electrodes and internal electrodes exposed to a surface opposing one surface are defined as second internal electrodes, the plurality of multilayer ceramic capacitors further include a first external electrode connected to the first internal electrodes and a second external electrode connected to the second internal electrodes.

12. The board of claim 11, wherein the composite electronic component further includes:
a positive electrode terminal connected to the tantalum wire and disposed outwardly of the molding part;
a negative electrode terminal connected to the body part of the tantalum capacitor and disposed outwardly of the molding part;
a first external terminal connected to the first external electrode and disposed outwardly of the molding part; and
a second external terminal connected to the second external electrode and disposed outwardly of the molding part.

13. The board of claim 12, wherein the first external electrodes of each of the plurality of multilayer ceramic capacitors are connected to each other by a common first external terminal, and the second external electrodes of each of the plurality of multilayer ceramic capacitors are connected to each other by a common second external terminal.

14. The board of claim 12, wherein the first external electrodes of the plurality of multilayer ceramic capacitors are connected to a plurality of first external terminals disposed to be spaced apart from each other, respectively, and the second external electrodes of the plurality of multilayer ceramic capacitors are connected to a plurality of second external terminals disposed to be spaced apart from each other, respectively.

15. The board of claim 12, wherein the positive electrode terminal and the negative electrode terminal are disposed on both side surfaces of the composite electronic component in a length direction of the composite electronic component, respectively, to be extended onto a lower surface of the composite electronic component, and the first and second external terminals are disposed on both side surfaces of the composite electronic component in a width direction of the composite electronic component to be extended onto the lower surface of the composite electronic component.

16. The board of claim 12, wherein the positive electrode terminal and the first external terminal are connected to each other, and the negative electrode terminal and second external terminal are connected to each other.
